(19) United States
(12) Patent Application Publication
(10) Pub. No.: US 2026/0363336 A1
(43) Pub. Date: Nov. 19, 2026

(54) AEROSOL PROVISION SYSTEM

(71) Applicant: Nicoventures Trading Limited, London (GB)

(72) Inventors: Darryl BAKER, London (GB); Nicholas ROSSER, London (GB); Connor BRUTON, London (GB); Mark CROSIER, Ipswich (GB); Robert KERSEY, Brighton (GB)

(21) Appl. No.: 19/750,827

(22) Filed: Jul. 22, 2026

Related U.S. Application Data
(63) Continuation of application No. 18/730,032, filed on Jan. 19, 2023.

(30) Foreign Application Priority Data
Jan. 21, 2022 (GB) 2200775.1

(51) Int. Cl. A24F 40/53; A24F 40/51; A24F 40/60

(52) U.S. Cl. CPC A24F 40/53; A24F 40/51; A24F 40/60

(57) ABSTRACT

There is provided an aerosol provision system comprising: an aerosol generating article comprising a data storage unit configured to store an identifier identifying a property of the aerosol generating article, the property relating to an eligibility of the aerosol generating article; an aerosol provision device comprising: a detector configured to detect a property of the aerosol generating article from the identifier; and, control circuitry configured to: change a performance state of the aerosol provision device based on the detected property of the aerosol generating article from the identifier; and, inform the user regarding the eligibility of the aerosol generating article.

### CROSS-REFERENCE TO RELATED APPLICATIONS

This application is a Continuation of U.S. Patent Application No. 18/730,032 filed Jul. 18, 2024, which is a National Phase entry of PCT Application No. PCT/GB2023/050105, filed Jan. 19, 2023, which claims priority from United Kingdom Application No. 2200775.1, filed Jan. 21, 2022, each of which are fully incorporated herein by reference in their entireties.

### TECHNICAL FIELD

The present invention relates to an aerosol provision system, a method of providing an aerosol from an aerosol provision system, and aerosol provision means.

### BACKGROUND

Aerosol provision systems are known. Common systems use heaters which are activated by a user to create an aerosol by an aerosol provision device from an aerosol generating material which is then inhaled by the user. The device may be activated by a user at the push of a button or merely by the act of inhalation. Modern systems can use consumable elements containing the aerosol generating material. It can be desirable for the manufacturer to enable control over the activation of the systems. This may avoid the activation of the system in undesirable circumstances.

The present invention is directed toward solving some of the above problems.

### SUMMARY

Aspects of the invention are defined in the accompanying claims.

In accordance with some embodiments described herein, there is provided an aerosol provision system comprising: an aerosol generating article comprising a data storage unit configured to store an identifier identifying a property of the aerosol generating article, the property relating to an eligibility of the aerosol generating article; an aerosol provision device comprising: a detector configured to detect a property of the aerosol generating article from the identifier; and, control circuitry configured to: change a performance state of the aerosol provision device based on the detected property of the aerosol generating article from the identifier; and, inform the user regarding the eligibility of the aerosol generating article.

Such a system is able to ensure that a user is informed when an attempt to use an undesirable consumable occurs. In particular, in the event that an attempt to use a recalled or out of date consumable is made, a user can be informed of such and act accordingly, such as replacing the consumable. In this way, the safety of use of the system is improved. An additional element of protection is provided by the changing of a performance state of the aerosol provision device based on the detected property. Some users may wish to use an out of date consumable without an appreciation for the impact of doing so, for example damage to the aerosol provision device. As such, preventing this from occurring while informing the user as to why this is the case, improves the protection of the device while ensuring the user appreciates why the device is not operating. This further improves the user’s experience of the device, as the indication allows the user to appreciate why the device is not operating.

In accordance with some embodiments described herein, there is provided an aerosol provision device comprising: a detector configured to detect a property of an aerosol generating article from an identifier of an aerosol generating article; and, control circuitry configured to: change a performance state of the aerosol provision device based on the detected property of an aerosol generating article from the identifier; and, inform the user regarding the eligibility of the aerosol generating article.

In accordance with some embodiments described herein, there is provided a method of providing an aerosol from an aerosol provision system, the method comprising: providing an aerosol generating article with a data storage unit configured to store an identifier identifying a property of the aerosol generating article, the property relating to an eligibility of the aerosol generating article; providing an aerosol provision device comprising a detector configured to detect a property of an aerosol generating article from an identifier of an aerosol generating article and control circuitry; detecting by the detector, the property of the aerosol generating article; changing, by the control circuitry, a performance state of the aerosol provision device based on the detected property of the aerosol generating article from the identifier; and, informing a user regarding the eligibility of the aerosol generating article.

In accordance with some embodiments described herein, there is provided aerosol provision means comprising: an aerosol generating article comprising a data storage means configured to store identifying means for identifying a property of the aerosol generating article, the property relating to an eligibility of the aerosol generating article; an aerosol provision device comprising: detecting means configured to detect a property of the aerosol generating article from the identifying means; and, control circuitry configured to: change a performance state of the aerosol provision device based on the detected property of the aerosol generating article from the identifying means; and, inform the user regarding the eligibility of the aerosol generating article.

### DESCRIPTION OF DRAWINGS

The present teachings will now be described by way of example only with reference to the following figures:

FIG. 1 is a schematic view of an aerosol provision system according to an example;

FIG. 2 is a schematic view of an aerosol provision system according to an example;

FIG. 3 is a schematic view of an aerosol provision system according to an example; and,

FIG. 4 is a flow diagram according to an example.

While the invention is susceptible to various modifications and alternative forms, specific embodiments are shown by way of example in the drawings and are herein described in detail. It should be understood, however, that the drawings and detailed description of the specific embodiments are not intended to limit the invention to the particular forms disclosed. On the contrary, the invention covers all modifications, equivalents and alternatives falling within the scope of the present invention as defined by the appended claims.

### DETAILED DESCRIPTION

Aspects and features of certain examples and embodiments are discussed / described herein. Some aspects and features of certain examples and embodiments may be implemented conventionally and these are not discussed / described in detail in the interests of brevity. It will thus be appreciated that aspects and features of apparatus and methods discussed herein which are not described in detail may be implemented in accordance with any conventional techniques for implementing such aspects and features.

The present disclosure relates to aerosol provision systems, which may also be referred to as aerosol provision systems, such as e-cigarettes. Throughout the following description the term “e-cigarette” or “electronic cigarette” may sometimes be used, but it will be appreciated this term may be used interchangeably with aerosol provision system / device and electronic aerosol provision system / device. Furthermore, and as is common in the technical field, the terms "aerosol" and "vapour", and related terms such as "vaporise", "volatilise" and "aerosolise", may generally be used interchangeably.

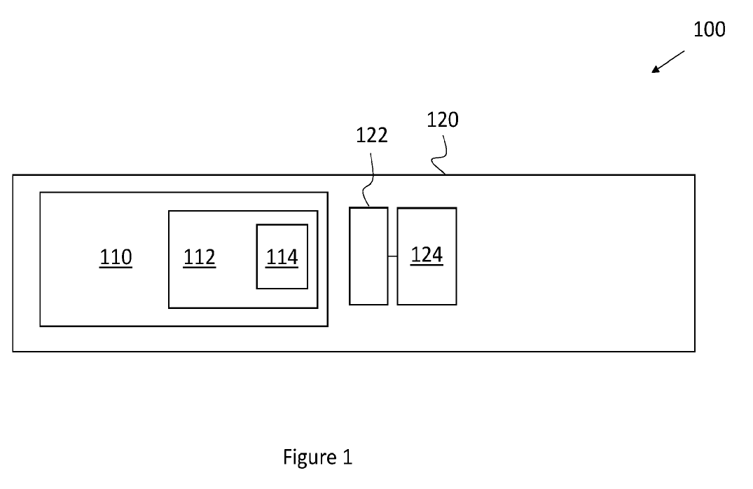

FIG. 1 illustrates a schematic view of an example of an aerosol provision system 100 according to the present invention. The aerosol provision system 100 has an aerosol generating article 110. The aerosol generating article 110 has a data storage unit 112 configured to store an identifier 114 identifying a property of the aerosol generating article 110. The property relates to an eligibility of the aerosol generating article 110. The aerosol provision system 100 has an aerosol provision device 120 comprising a detector 122 configured to detect a property of the aerosol generating article 110 from the identifier 114. The aerosol provision device 120 has control circuitry 124 configured to change a performance state of the aerosol provision device 120 based on the detected property of the aerosol generating article 110 from the identifier 114. The control circuitry 124 can inform the user regarding the eligibility of the aerosol generating article 110.

In the example shown in FIG. 1, the aerosol generating article 110 is shown located inside the aerosol provision device 120 forming the aerosol provision system 100. In this example, the aerosol generating article 110 may be inserted into the housing of the aerosol provision device 120. In this way, when located inside the aerosol provision device 120 the detector 122 may detect the property of the aerosol generating article 110 from the identifier 114. The aerosol generating article 110 may be a consumable or a cartridge containing an aerosolisable material which is inserted into the aerosol provision device 120 and then discarded after use.

The identifier 114 may be a coded identifier such as a QR code or a bar code or the like which can be read by the detector 122. The detector 122 corresponds to the identifier 114 such that, if the identifier 114 is a QR code, the detector 122 is a QR code reader. The identifier 114 may be an RFID and the detector 122 may be an RFID reader. Other identifier/detector pairs are possible.

The identifier 114 identifies a property of the aerosol generating article 110. The property relates to an eligibility of the aerosol generating article 110. The property may be any of a use-by date of the aerosol generating article 110, a date of production of the aerosol generating article 110, a batch number of the aerosol generating article 110 and, a status of the aerosol generating article 110. The status of the aerosol generating article 110 may relate to whether the aerosol generating article 110 has been recalled, is no longer supported, or any similar status that might impact the suitability of the aerosol generating article 110 for use in the aerosol provision device 120. Such properties may therefore disclose the age of the aerosol generating article 110 or the shelf life or the like. In this way, the detector 122 detects the identifier 114 and the system 100 notes the property associated with the identifier 114. The system 100 can then act accordingly from the property as follows.

If the aerosol generating article 110 has a use-by date in the past, the eligibility of the aerosol generating article 110 may be deemed as ineligible. In this case, the control circuitry 124 of the aerosol provision device 120 may change the performance state of the aerosol provision device 120 to a non-operating state. In this way, a user may not be able to operate the aerosol provision device 120 to provide an aerosol from the ineligible aerosol generating article 110 by virtue of its eligibility. In this way, the user may be prevented from providing a substandard aerosol from the aerosol generating article 110.

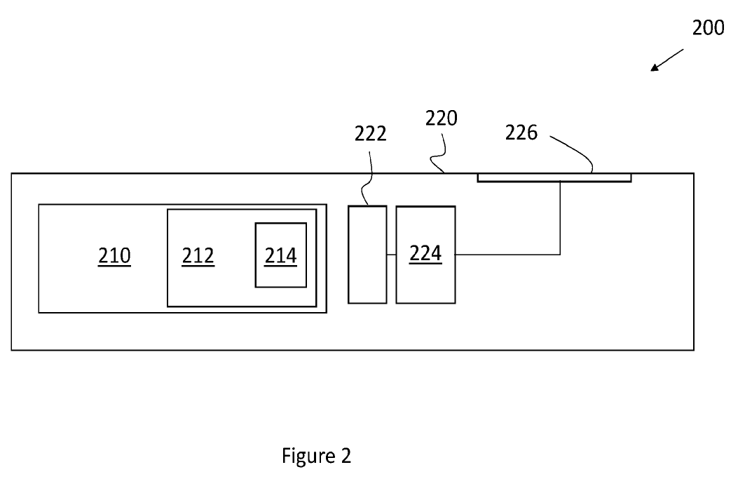

Referring now to FIG. 2, there is a shown a similar system 200 to the system 100 of FIG. 1. Similar features, to those features used in FIG. 1, are shown with the reference numerals increased by 100. For example, the system 100 of FIG. 1 is similar to the system 200 of FIG. 2. Similar or identical features may not be discussed for conciseness.

The system 200 of FIG. 2 has an indicating element 226 for indicating to the user an eligibility of the aerosol generating article 210. The indicating element 226 is connected to the control circuitry 224 of the aerosol provision device 220.

The indicating element 226 may be a display, for displaying a visual signal to the user. The indicating element 226 may be a haptic mechanism, for providing a haptic signal to the user. The indicating element 226 may be a light array, for providing a visual signal to the user. In this way, the user may be informed of the eligibility of the aerosol generating article 210 once this has been determined by the aerosol provision device 220. The user may be alerted to the eligibility of the aerosol generating article 210 by a message on a display, which may be text or pictures or the like. The haptic arrangement may provide a series of signals to the user to indicate eligibility. The light array may provide colours associated with eligibility, where for example red indicates not eligible and green indicates eligible.

While the user may receive an indication as to the eligibility of the aerosol generating article 210 in any circumstance, it may be that the device 220 provides an indication only in situations when the aerosol generating article 210 is ineligible for use in the device 220. In this way, the user is provided with an appreciation as to why the device 220 is not operating and how to rectify the situation (by providing a new aerosol generating article 210 into the aerosol provision device 220). This improves the user’s experience of the device 220 and does not use energy to provide an indication that the aerosol generating article 210 is eligible when this can be inferred from correct operation of the device 220.

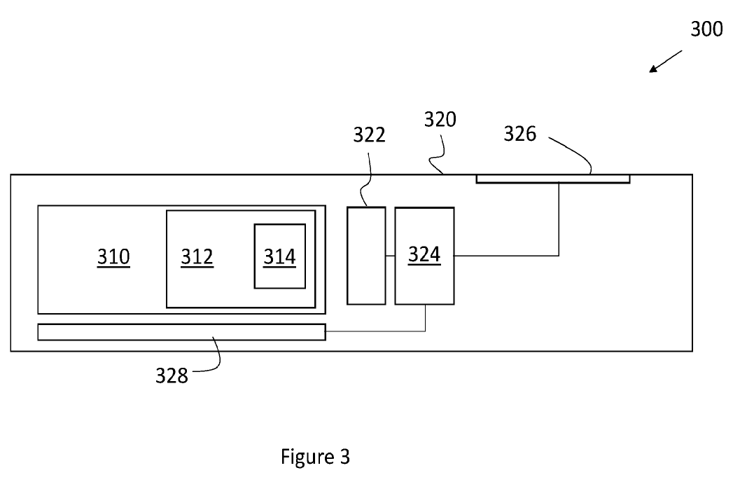

Referring now to FIG. 3, there is a shown a similar system 300 to the system 200 of FIG. 2. Similar features, to those features used in FIG. 2, are shown with the reference numerals increased by 100. For example, the system 200 of FIG. 2 is similar to the system 300 of FIG. 3. Similar or identical features may not be discussed for conciseness.

The aerosol provision device 320 of FIG. 3 has a heater 328. The heater 328 may be a heating element, atomiser, heater, vibrating plate or the like suitable for forming an aerosol from an aerosol generating article 310. The heater 328 is connected to the control circuitry 324. The control circuitry 324 upon determining or receiving the eligibility of the aerosol generating article 310, may send a signal to the heater 328 to either operate such that an aerosol is produced, or not operate so that an aerosol is not produced. In this way, the control circuitry 324 may be configured to change a performance state of the aerosol provision device 320 to a non-operating state upon detecting that the property relates to an ineligible aerosol generating article 310.

The determination of the eligibility of the aerosol generating article 310 may occur on the aerosol provision device 320 or remotely, via communication with a database of properties and associated eligibilities. Such a database may for example take the form of use-by date, if before X, then eligibile, if after X, then ineligible. Similar data can be held or provided for each category discussed herein.

In the example where the processing of the property and associated eligibility is performed on the aerosol provision device 320, the detector 322 may detect the property of the aerosol generating article 310 from the identifier 314 and compare the property against a database of properties and associated eligibilities in the detector 322. The detector 322 may then provide a signal to the control circuitry 324 that the aerosol generating article 310 is or is not eligible. The control circuitry 324 may then signal the indicating element 326 and the heater 328 accordingly.

In another example, the detector 322 may send an indication of the property to the control circuitry 324 which compares the property of the aerosol generating article 310 against a database of properties and associated eligibilities in the control circuitry 324. Subsequent signals may be sent to the indicating element 326 and the heater 328 accordingly.

In the above two examples, the database of properties and associated eligibilities is carried on the aerosol provision device 320 in either the detector 322 or the control circuitry 324 or in an additional memory element. This may be advantageous as the system 300 need not have a communications element in the system 300 and it need not be connected to a communications network to access a remotely held database prior to each use session.

In a further example, the database of properties and associated eligibilities is held remotely, and the control circuitry has a communications element to contact the database. The control circuitry 324 may contact the database and be provided with an indication as to whether the aerosol generating article 310 is eligible or not. This may be advantageous as the system 300 need not include a memory element for carrying the database and the database can be remotely updated ensuring the device need not have the onboard database regularly updated such that recently recalled products (or the like) are prevented from being used as soon as the products are announced as recalled.

The aerosol provision device 320 may be in a default performance state prior to any use by a user. This default performance state may be a non-operating state. In such an example, a user may not operate the aerosol provision device 320 until eligibility of the aerosol generating article 310 has been confirmed via the detector 322 and control circuitry 324. In another example, there need not be such a default state, and the arrangement is such that the device 320 will operate on an eligible aerosol generating article 310 and will not operate on an ineligible aerosol generating article 310.

In the event that the aerosol generating article 310 is not eligible, upon receipt of a signal from the detector 322, the control circuitry 324 may send a signal to the heater 328 to not operate (or send no signal to operate) and also send a signal to the indicating element 326 to provide an indication to the user that the aerosol generating article 310 is to be removed and replaced. In the event that the aerosol generating article 310 is eligible, upon receipt of a signal from the detector 322, the control circuitry 324 may send a signal to the heater 328 to operate and thereby provide an aerosol. A signal may also be sent to the indicating element 326 to inform the user the aerosol generating article 310 is eligible.

The user may initiate activation of the heater 328 from an additional input, such as a button or by puffing on the device 320. In this arrangement, the control circuitry 324 may determine that the aerosol generating article 310 is eligible, provide the user an indication of this, indicate to the heater 328 that it may be operated (pending a request from the user in the form of a button push of a puff), and then the user can opt to operate the heater by pressing a button or puffing. In this way, the user can insert the aerosol generating article 310, determine if the aerosol generating article 310 is eligible, but opt to use the device 320 later. Such an arrangement is advantageous as it allows a user to check the eligibility of the aerosol generating article 310 prior to a session. Upon removal of the aerosol generating article 310, the control circuitry 324 may indicate to the heater 328 to be in a non-operating state until another eligible aerosol generating article 310 is identified.

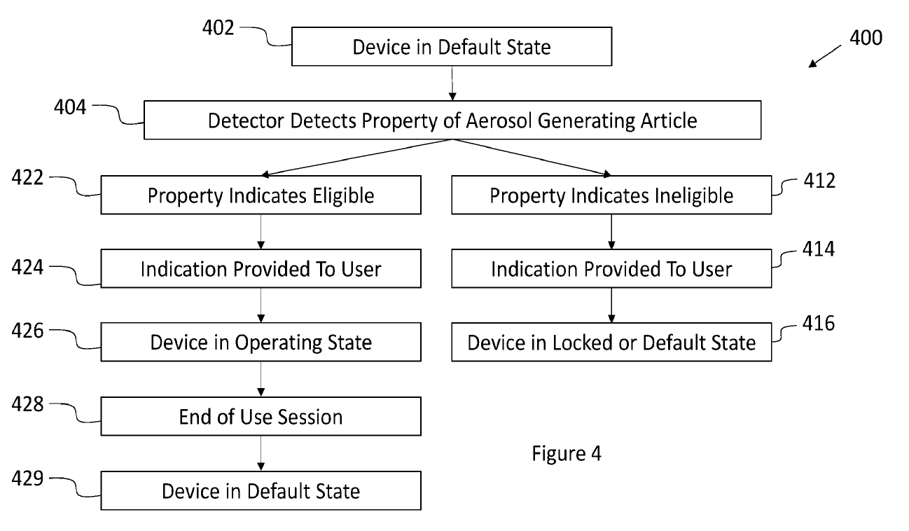

FIG. 4 shows a method 400 of use of an aerosol provision system. In the method 400, the device may start in a default state 402, which may be a non-operating state such that the heater cannot be made to operate. When a user inserts an aerosol generating article into the aerosol provision device, the detector detects the property of the aerosol generating article 404. The detector sends a signal to the control circuitry according to the detected property of the aerosol generating article. As discussed above, one of the detector or control circuitry compares the property against a memory, database or the like to confirm the eligibility (eligible or ineligible) of the aerosol generating article. If an ineligible aerosol generating article is detected 412, the property indicates the aerosol generating article is ineligible, the method goes on to step 414 wherein the an indication is provided to the user 414 and the device is put in state which may be the default state or a locked state.

A locked state may be used when repeated attempts to use ineligible aerosol generating articles have been made. In this way, the device can be protected against attempted hacks or the like. Similarly, the user may be provided with an indication that such attempts have been made, in case an unauthorised user has attempted to use the device without permission and with ineligible aerosol generating articles. The locked state may be changed back to a default, non-operating or operating state by provision of an eligible aerosol generating article or by the input of a password, passcode or the like as might be known only by the user. This increases the overall protection provided to the device by the present system.

If an eligible aerosol generating article is detected 422, an indication of such is provided to a user 424. The device is changed to being in an operating state 426. The heater or atomiser may be operated, either automatically or on request from a further input by the user (button or inhalation or the like). In this way an aerosol may be provided to the user. After the user has ended their session, which may be indicated to the device by the user by pressing a button or after a given period of time or after a predetermined number of puffs, the use session is ended or deemed to have ended 428. After this, the device is returned to the default state 429 as in step 402. As such, the user and the device can be protected against use of the device with ineligible aerosol generating articles.

The “performance state” of the aerosol provision device may, broadly, be considered as one or more of operating or non-operating states. Signals provided by the detector may be received by the control circuitry and ultimately result in changing the aerosol provision device from one state to another.

In an “operating state”, elements of the aerosol provision device used to generate an aerosol (such as an atomiser, heater or the like) may be activated. The specific activation of the device may require an additional input which may be inhalation on the device, pressing a button on the device or the like, alternatively the device may automatically generate aerosol by the heater upon receiving a signal, regarding eligibility of the aerosol generating article from the control circuitry.

In a “non-operating state”, elements of the aerosol provision device used to generate an aerosol (such as an atomiser, heater or the like) may not be activated. In this example, inhaling on the device or pressing a button makes no impact on the heater or atomiser etc.

The term “operating state” may refer to a number of states in which the device 110 can be operated. Similarly the term “non-operating state” may refer to a number of states in which the device 110 cannot be operated.

A “locked” state may be a form of non operating state wherein, before the device can be used to provide an aerosol, an eligible aerosol generating article must be detected by the detector to override the locked state. A locked state may require a further level of identification of an authorised user to enable the locked state to be changed to an unlocked operating state. This may be in the form of a password, passkey, alphanumerical sequence or the like. The use of such a locked state provides an indication to the authorised user than an attempt has been made to use the device by a user using ineligible aerosol generating articles. Such a locked state may only be used when several attempts have been made to use ineligible aerosol generating articles.

The term “operating state” refers to a state in which the system may be used to provide an aerosol. A system may have a large number of “operating states” or just one. Specific aerosol generating articles may provide a suitable aerosol for a user under a suitable heating profile (fast, slow, high temperature, low temperature, etc.) or via a suitable heating mechanism (heater element, atomiser, vibrating plate, etc.). As such specific, operating states may dictate the performance of the system, such as selecting the heating mechanisms used and the heating profile used based on the identified aerosol generating articles. Such operating states may be associated with specific aerosol generating articles. In this way, upon recognition of eligible aerosol generating article 1, corresponding heating mechanism 1 is used to provide heating profile 1 on the eligible aerosol generating article 1. Upon recognition of eligible aerosol generating article 2, corresponding heating mechanism 2 is used to provide heating profile 2 on eligible aerosol generating article 2. In this way, different aerosol generating articles can have a suitable predetermined aerosol provided upon recognition of that aerosol generating article. This improves the ease of use of a device for a user.

The eligibility of an aerosol generating article may be either eligible or ineligible. In this case, the device may operate on an eligible article and not operate on an ineligible article. In another example the eligibility of an aerosol generating article may be categorised as one of eligible, ineligible or user-decision. In this instance: a fresh, new aerosol generating article could be eligible and used to provide an aerosol; an old aerosol generating article may be ineligible and prevented by the device from providing an aerosol; and, a somewhat old aerosol generating article may be indicated to the user as being somewhat old and the user can decide whether to produce an aerosol from that aerosol generating article. In this way, the user has more agency over the decision on whether to produce an aerosol. The user may, with an understanding that the aerosol may be slightly lower quality than they are used to, still opt to produce an aerosol. In this example, the user is protected from bad quality or expired (or the like) aerosol generating articles, allowed to use high quality aerosol generating articles, and is given the choice for more middle ground quality aerosol generating articles. In this last instance, the indicating element may provide a different signal to the user for middle ground quality aerosol generating articles from the signal for bad quality or high quality aerosol generating articles. The user may then opt to activate the device using a push button, inhalation or the like or alternatively opt to remove the aerosol generating article from the device and discard.

In a particular example, the device disclosed herein may operate with a flavour pod which is replaceable in the device. The flavour may be any of tobacco and glycol and may include extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamon, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof.

When combined with an aerosol generating medium, the aerosol provision device as disclosed herein may be referred to as an aerosol provision system.

Thus there has been described an aerosol provision system comprising: an aerosol generating article comprising a data storage unit configured to store an identifier identifying a property of the aerosol generating article, the property relating to an eligibility of the aerosol generating article; an aerosol provision device comprising: a detector configured to detect a property of the aerosol generating article from the identifier; and, control circuitry configured to: change a performance state of the aerosol provision device based on the detected property of the aerosol generating article from the identifier; and, inform the user regarding the eligibility of the aerosol generating article.

The aerosol provision system may be used in a tobacco industry product, for example a non-combustible aerosol provision system.

In one embodiment, the tobacco industry product comprises one or more components of a non-combustible aerosol provision system, such as a heater and an aerosolizable substrate.

In one embodiment, the aerosol provision system is an electronic cigarette also known as a vaping device.

In one embodiment the electronic cigarette comprises a heater, a power supply capable of supplying power to the heater, an aerosolizable substrate such as a liquid or gel, a housing and optionally a mouthpiece.

In one embodiment the aerosolizable substrate is contained in or on a substrate container. In one embodiment the substrate container is combined with or comprises the heater.

In one embodiment, the tobacco industry product is a heating product which releases one or more compounds by heating, but not burning, a substrate material. The substrate material is an aerosolizable material which may be for example tobacco or other non-tobacco products, which may or may not contain nicotine. In one embodiment, the heating device product is a tobacco heating product.

In one embodiment, the heating product is an electronic device.

In one embodiment, the tobacco heating product comprises a heater, a power supply capable of supplying power to the heater, an aerosolizable substrate such as a solid or gel material.

In one embodiment the heating product is a non-electronic article.

In one embodiment the heating product comprises an aerosolizable substrate such as a solid or gel material, and a heat source which is capable of supplying heat energy to the aerosolizable substrate without any electronic means, such as by burning a combustion material, such as charcoal.

In one embodiment the heating product also comprises a filter capable of filtering the aerosol generated by heating the aerosolizable substrate.

In some embodiments the aerosolizable substrate material may comprise an aerosol or aerosol generating agent or a humectant, such as glycerol, propylene glycol, triacetin or diethylene glycol.

In one embodiment, the tobacco industry product is a hybrid system to generate aerosol by heating, but not burning, a combination of substrate materials. The substrate materials may comprise for example solid, liquid or gel which may or may not contain nicotine. In one embodiment, the hybrid system comprises a liquid or gel substrate and a solid substrate. The solid substrate may be for example tobacco or other non-tobacco products, which may or may not contain nicotine. In one embodiment, the hybrid system comprises a liquid or gel substrate and tobacco.

In order to address various issues and advance the art, the entirety of this disclosure shows by way of illustration various embodiments in which the claimed invention(s) may be practiced and provide for a superior electronic aerosol provision system. The advantages and features of the disclosure are of a representative sample of embodiments only, and are not exhaustive and/or exclusive. They are presented only to assist in understanding and teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope and/or spirit of the disclosure. Various embodiments may suitably comprise, consist of, or consist essentially of, various combinations of the disclosed elements, components, features, parts, steps, means, etc. In addition, the disclosure includes other inventions not presently claimed, but which may be claimed in future.

1. An aerosol provision device comprising:
a detector configured to detect a property of an aerosol generating article from an identifier of the aerosol generating article;
a heater for forming an aerosol from the aerosol generating article, wherein the heater is configured to heat a solid aerosolisable substrate comprising tobacco;
an indicating element for indicating to a user an eligibility of the aerosol generating article, wherein the indicating element is configured to provide a visual signal or a haptic signal; and,
control circuitry configured to:
upon detecting, using the detector, that the property relates to an eligible aerosol generating article, change a performance state of the aerosol provision device to an operating state such that the heater is automatically activated;
upon detecting, using the detector, that the property relates to an ineligible aerosol generating article, change a performance state of the aerosol provision device to a non-operating state such that the heater is not activated, and inform the user regarding the eligibility of the aerosol generating article by the indicating element; and
upon detecting, using the detector, that the property relates to neither an eligible nor an ineligible aerosol generating article, inform the user regarding the eligibility of the aerosol generating article by the indicating element, and permit a user to activate the heater,
wherein for the aerosol generating article to be heated, the control circuitry is further configured to:
select a heating profile for the aerosol generating article; and
control the heater according to the heating profile for the aerosol generating article,
wherein the heating profile for the aerosol generating article comprises a temperature profile of the heater, and wherein for a first aerosol generating article, the control circuitry is configured to select a first heating profile, and wherein for a second aerosol generating article, the control circuitry is configured to select a second, different, heating profile.

2. The aerosol provision device according to claim 1, further comprising a button, and when the user is permitted to activate the heater, activation of the heater occurs when the user presses the button.

3. The aerosol provision device according to claim 1, wherein when the user is permitted to activate the heater, activation of the heater occurs when the user inhales on the device.

4. The aerosol provision device according to claim 1, wherein the indicating element comprises at least one of:
a display, for displaying the visual signal to the user;
a haptic mechanism, for providing the haptic signal to the user; and,
a light array, for providing the visual signal to the user.

5. The aerosol provision device according to claim 1, wherein the property of the aerosol generating article is at least one of:
a use-by date of the aerosol generating article;
a date of production of the aerosol generating article;
a batch number of the aerosol generating article; and,
a status of the aerosol generating article.

6. The aerosol provision device according to claim 1, wherein the control circuitry is arranged to access a database of properties and related eligibilities of aerosol generating articles.
